(19) United States
(12) Patent Application Publication
(10) Pub. No.: US 2014/0218906 A1
(43) Pub. Date: Aug. 7, 2014

(54) TRACK LIGHT DEVICE

(71) Applicant: Diode-On Optoelectronics Limited, Taichung City (TW)

(72) Inventor: Ivan Liu, Taichung City (TW)

(21) Appl. No.: 13/928,551

(22) Filed: Jun. 27, 2013

(30) Foreign Application Priority Data
Feb. 6, 2013 (TW) 102202599

(51) Int. Cl. F21V 21/14

(52) U.S. Cl. CPC F21V 21/14
USPC 362/220

(57) ABSTRACT

A track light device includes a track, a track light and at least one light bar. The track extends along a longitudinal axis. The track light is mounted slidably to the track. The light bar is disposed fixedly on an outer surface of the track unit and extends along the longitudinal axis for providing uniform illumination.

### BACKGROUND OF THE INVENTION

1. Field of the Invention

This invention relates to a track light device, more particularly to a track light device including a movable track light and a stationary light bar.

2. Description of the Related Art

In general, a display cabinet is equipped with a light source, e.g., a track light for lighting objects, e.g., jewelry or antiques and improving their aesthetic appeal.

Taiwanese Utility Model Patent No. M289833 discloses a conventional track light device that includes a track and a lamp coupled slidably to the track. However, the conventional track light device provides a relatively concentrated light projection and is unable to provide uniform luminance for the display cabinet.

### SUMMARY OF THE INVENTION

Therefore, an object of the present invention is to provide a track light device that provides a relatively uniform luminance for a display cabinet and that occupies a relatively small space.

Accordingly, a track light device of this invention includes a track extending along a longitudinal axis, a track light mounted slidably to the track, and at least one light bar disposed fixedly on an outer surface of the track and extending along the longitudinal axis for providing uniform illumination.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a track light device according to the first preferred embodiment of the invention;

FIG. 2 is a sectional view of the first preferred embodiment; and

FIG. 3 is a sectional view of a track light device according to the second preferred embodiment according to the invention.

### DETAILED DESCRIPTION OF THE PREFERRED EMBODIMENTS

Before the present invention is described in greater detail, it should be noted herein that like elements are denoted by the same reference numerals throughout the disclosure.

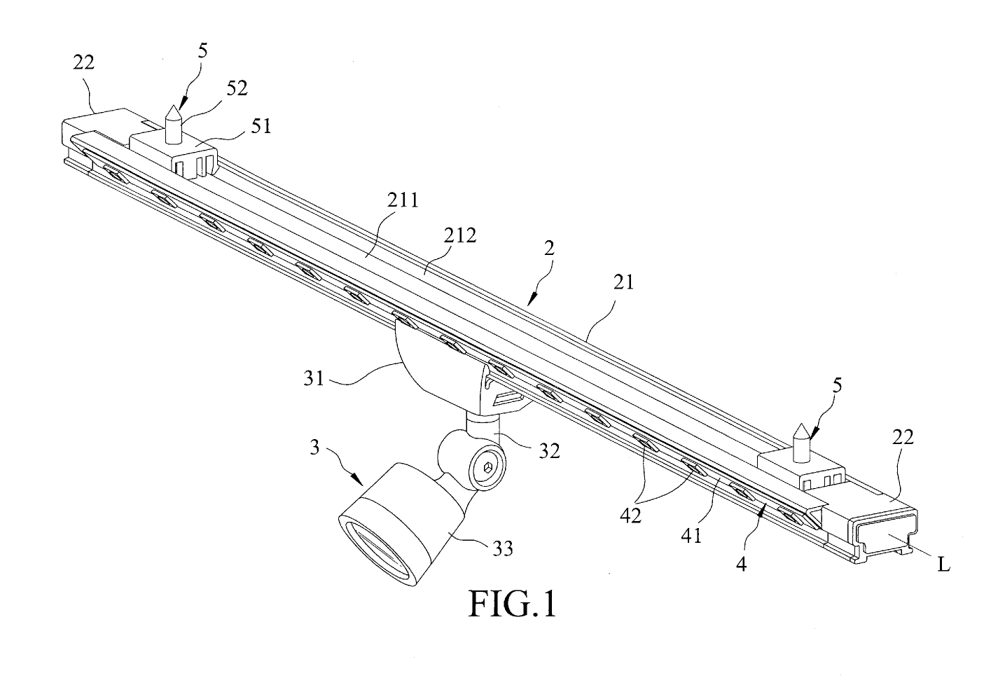

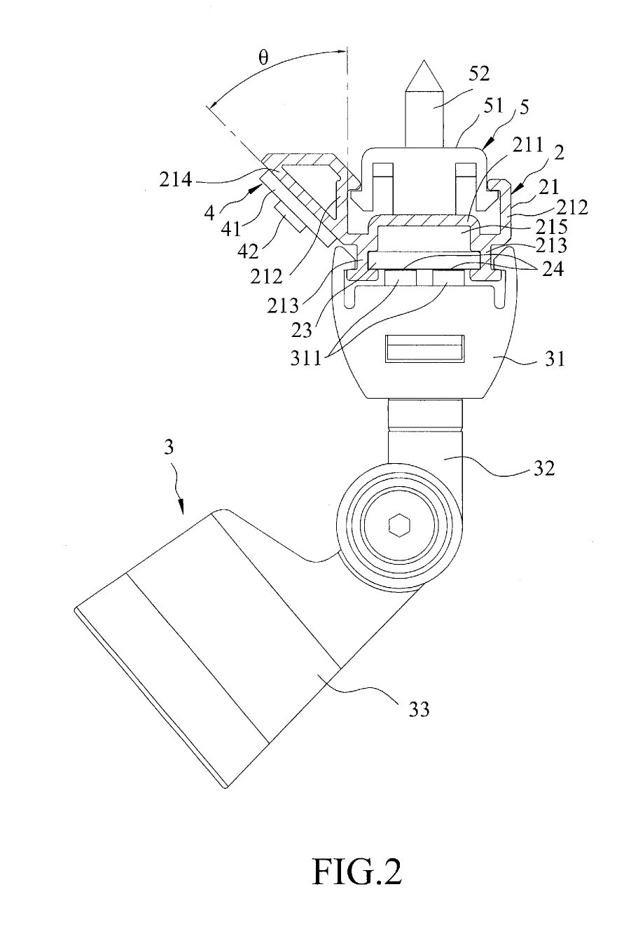

Referring to FIGS. 1 and 2, the first preferred embodiment of a track light device according to this invention includes a track unit 2, a track light 3, a light bar 4 and two fixing members 5.

The track unit 2 includes a track 21 extending along a longitudinal axis (L), and has a main portion 211, a pair of extending portions 212, two engaging portions 213 and an oblique portion 214. The main portion 211 extends along the longitudinal axis (L). The extending portions 212 extend along the longitudinal axis (L), are formed respectively on opposite ends of the main portion 211, and are perpendicular to the main portion 211. The engaging portions 213 extend from the main portion 211 in a direction opposite to the extending portions 21, and cooperate with the main portion 211 to define an accommodating slot 215. The oblique portion 214 is connected to and defines an angle (θ) with one of the extending portions 212, and extends along the longitudinal axis (L). The angle (θ) between said one of the extending portions 212 and the oblique portion 214 of the track 21 is configured to range from 0 degree to 90 degrees. In this embodiment, the angle (θ) is 45 degrees, and the track 21 is formed into one piece by aluminum extrusion to reduce weight of the track 21 while maintaining a good structural strength thereof. It should be noted that, in other embodiments of this invention, the oblique portion 214 may be connected pivotally to said one of the extending portions 212 so that the angle (θ) is adjustable.

The track unit 2 further includes a pair of end covers 22 disposed on opposite ends of the track 21 along the longitudinal axis (L), a track circuit board 23 disposed in the accommodating slot 215, and a pair of fixed electrodes 24 secured to the track circuit board 23.

The track light 3 includes an engaging member 31, a rotatable shaft 32 and a lamp seating 33. The engaging member 31 engages slidably the accommodating slot 215 of the track 21, and has a pair of contact electrodes 311 connected electrically and respectively to the fixed electrodes 24 on the track circuit board 23. The rotatable shaft 32 has an end connected rotatably to the engaging member 31 and another end connected pivotally to the lamp seating 33 is connected pivotally to an opposite end of the rotatable shaft 32. Since the structure of the track light 3 is known in the art, further details of the same are omitted herein for the sake of brevity.

The light bar 4 includes a lamp circuit board 41 and a plurality of spaced-apart light emitting diodes 42. The lamp circuit board 41 is disposed fixedly on an outer surface of the oblique portion 214 of the track 21 and extends along the longitudinal axis (L). The light emitting diodes 42 are disposed on the lamp circuit board 41.

The fixing members 5 are connected to the track 21 and adapted for fixing the track light device to a reference surface (not shown). Each of the fixing members 5 includes a fixing block 51 and a fixing pin 52. The fixing block 51 is connected removably to the extending portions 212 of the track 21. The fixing pin 52 is connected to the fixing block 51 and adapted to be connected to the reference surface.

Accordingly, being mounted with a track light 3 and a light bar 4, the track light device of this invention can provide both concentrated and uniform illumination as required without increasing the installation space thereof.

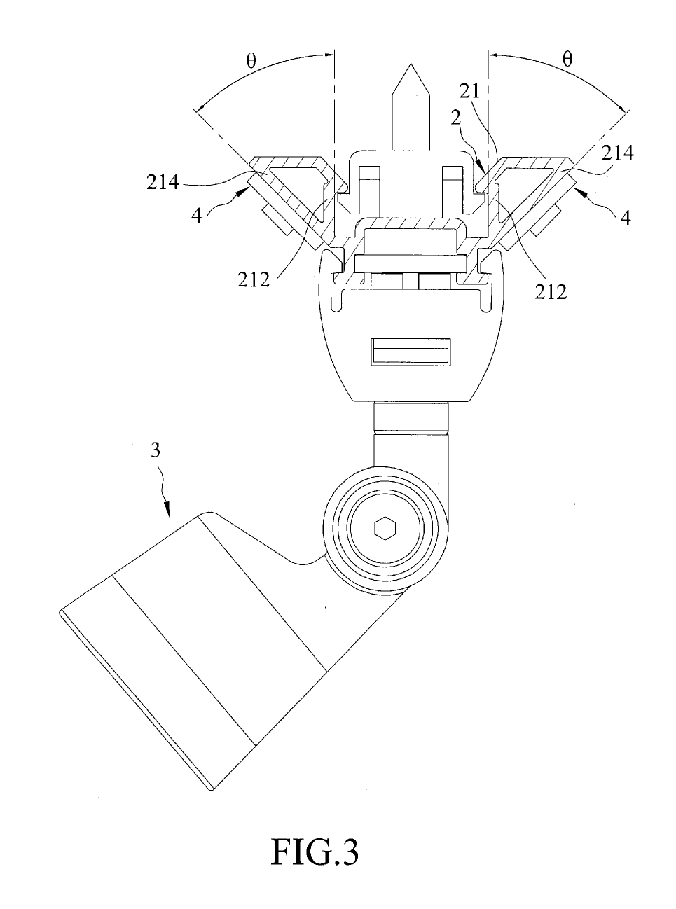

Referring to FIG. 3, the second preferred embodiment of the track light device according to this invention has a structure similar to that of the first preferred embodiment. The main difference between this embodiment and the previous embodiment resides in the following. In this embodiment, the track 21 has a pair of oblique portions 214 connected respectively to the extending portions 212. Each of the oblique portions 214 defines an angle (θ) with the respective one of the extending portions 212. Two light bars 4 are mounted respectively to the oblique portions 214 of the track 21, such that the track light device of this embodiment can provide uniform illumination simultaneously in different directions.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A track light device comprising:
a track extending along a longitudinal axis;
a track light mounted slidably to said track; and
at least one light bar disposed fixedly on an outer surface of said track and extending along the longitudinal axis for providing uniform illumination.

2. The track light device of claim 1, wherein said track has
a main portion extending along the longitudinal axis,
a pair of extending portions extending along the longitudinal axis, formed respectively on opposite ends of said main portion and perpendicular to said main portion,
an engaging portion extending from said main portion in a direction opposite to said extending portions, and cooperating with said main portion to define an accommodating slot, said track light engaging slidably said accommodating slot, and
an oblique portion connected to and defining an angle with one of said extending portions, extending along the longitudinal axis, and mounted with said light bar.

3. The track light device of claim 2, further comprising a pair of end covers disposed on opposite ends of said track along the longitudinal axis, a track circuit board disposed in said accommodating slot and electrically connected to said track light.

4. The track light device of claim 3, wherein:
said track light includes an engaging member engaging slidably said track, a rotatable shaft connected rotatably to said engaging member, and a lamp seating connected pivotally to said rotatable shaft; and
said engaging member has at least a pair of contact electrodes, said track light device further comprising two fixed electrodes secured to said track circuit board for contacting respectively said contact electrodes.

5. The track light device of claim 2, wherein the angle between said one of said extending portions and said oblique portion of said track ranges from 0 degree to 90 degrees.

6. The track light device of claim 5, wherein the angle is 45 degrees.

7. The track light device of claim 2, wherein said track is formed into one piece by aluminum extrusion.

8. The track light device of claim 2, further comprising at least one fixing member connected to said track and adapted for fixing said track light device to a reference surface.

9. The track light device of claim 8, wherein said fixing member includes a fixing block connected removably to said extending portions of said track, and a fixing pin connected to said fixing block and adapted to be connected to the reference surface.

10. The track light device of claim 2, wherein said light bar includes a lamp circuit board disposed fixedly on an outer surface of said oblique portion of said track and extending along the longitudinal axis, and a plurality of spaced-apart light emitting diodes disposed on said lamp circuit board.

11. The track light device of claim 2, wherein said oblique portion is connected pivotally to said one of said extending portions of said track so that the angle between said one of said extending portions and said oblique portion of said track is adjustable.

12. The track light device of claim 1, wherein said track is formed into one piece by aluminum extrusion.

13. The track light device of claim 1, wherein:
said track has
a main portion extending along the longitudinal axis,
a pair of extending portions extending along the longitudinal axis, formed respectively on opposite ends of said main portion and perpendicular to said main portion,
an engaging portion extending from said main portion in a direction opposite to said extending portions, engaging said track light, and cooperating with said main portion to define an accommodating slot, and
a pair of oblique portions connected respectively to said extending portions and extending along the longitudinal axis, each of said oblique portions defining an angle with the respective one of said extending portions; and
said track light comprises two of said light bars mounted respectively to said oblique portions of said track.

14. The track light device of claim 13, wherein said oblique portions are connected pivotally to said extending portions of said track, respectively.
